(19) United States
(12) Patent Application Publication
(10) Pub. No.: US 2018/0208813 A1
(43) Pub. Date: Jul. 26, 2018

(54) POLY(UREA-URETHANE) COMPRISING POLYURETHANE-POLYETHER AND POLYURETHANE-POLYESTER BLOCKS AND AN ALKOXYSILANE END GROUP

(71) Applicant: BOSTIK SA, La Plaine Saint-Denis (FR)

(72) Inventors: Aurelie BOYER, Mont L'Eveque (FR); Olivier LAFERTE, Trosly Breuil (FR)

(73) Assignee: BOSTIK SA, La Plaine Saint-Denis (FR)

(21) Appl. No.: 15/746,076

(22) PCT Filed: Jul. 19, 2016
(86) PCT No.: PCT/FR2016/051851

§ 371 Date: Jan. 19, 2018

(30) Foreign Application Priority Data
Jul. 21, 2015 (FR) 15.56910

(51) Int. Cl. C09J 175/08; C09J 5/00; C08G 18/10; C08G 18/22; C08G 18/42; C08G 18/76; C08G 18/48; C08G 18/40; C08G 18/83

(52) U.S. Cl. CPC C09J 175/08; C09J 5/00; C08G 18/10; C08G 18/227; C09J 2475/00; C08G 18/7621; C08G 18/4833; C08G 18/4018; C08G 18/837; C08G 18/4238

(57) ABSTRACT

1) Process for preparing a poly(urea-urethane) comprising blocks of polyurethane-polyether and polyurethane-polyester type, two blocks of the same type each being connected to an alkoxysilane end group via a urea function, said process comprising:
(i) the reaction of a polyether polyol A₁ with a stoichiometric excess of a diisocyanate B⁽ⁱ⁾; and then
(ii) the reaction of the polyurethane produced in step (i) with a stoichiometric excess of a polyester polyol A₂; and then
(iii) the reaction of the polyurethane produced in step (ii) with a stoichiometric excess of a diisocyanate B⁽ⁱⁱⁱ⁾; and then
(iv) the reaction of the polyurethane produced in step (iii) with a stoichiometric amount of an aminosilane C.

2) Poly(urea-urethane) formed via said process.

3) Corresponding adhesive composition, also comprising a crosslinking catalyst.

4) Process for assembling two substrates using said composition.

The present invention relates to a poly(urea-urethane) bearing an alkoxysilane end group, which has, after crosslinking, advantageous mechanical properties allowing its use as an adhesive or mastic, especially as a hot-melt adhesive. The present invention also relates to a process for preparing poly(urea-urethane) and to an adhesive composition comprising same. Finally, the invention relates to an assembly process using said composition.

Polymers are known bearing an alkoxysilane end group, for which said group is connected, directly or indirectly, to a main chain which is constituted of a polyether chain.

Such polymers, which are generally known in the adhesives field under the name MS Polymers® (derived from the term “Modified Silane Polymers”), are commercially available from the company Kaneka. These polymers, with a molecular mass generally between 10 and 50 kDa, which are generally liquid, are widely used in many industrial fields and in everyday life because of their assembly by bonding of a wide variety of objects (also termed substrates), which may be made of a wide variety of materials.

Such a polymer is first applied, in combination with a catalyst and in the form of an adhesive layer, to at least one of the two faces that belong, respectively, to the two substrates to be assembled and which are intended to be placed in contact with each other in the assembly. After placing the two substrates in contact and, where appropriate, applying pressure to their contact surface, the polymer reacts with the water that is in the surrounding medium in the form of atmospheric moisture or moisture provided by said substrates.

This reaction, known as a crosslinking reaction, leads, once it is complete, to the formation of an adhesive bond between the two substrates which is constituted by the polymer crosslinked into a three-dimensional network formed by the polymer chains connected together via bonds of siloxane type. This bond ensures the solidness of the assembly of the two substrates thus obtained.

However, the mechanical properties of crosslinked MS Polymers®, especially their cohesion, are generally insufficient for many applications, corresponding to those for which the adhesive bond must be capable of relatively rapidly withstanding high stresses.

Specifically, the final cohesion of the adhesive bond is not obtained until after the crosslinking reaction is complete, i.e. after a certain amount of time (known as the cohesion increase time or the setting time or the solidification time) which may range in practice up to 48 hours, and during which the assembly cannot be conveniently manipulated or even must occasionally be maintained by mechanical gripping means (for example pincers or vices). MS Polymers® consequently have the drawback of having no “green strength” or largely insufficient “green strength”.

This term “green strength” denotes the ability of an adhesive to immediately ensure suitable cohesion of the adhesive bond, by virtue of a high initial rate of cohesion increase of said bond, as soon as the two substrates intended to be assembled by bonding are placed in contact. A good green strength level avoids the difficulties observed during the setting time. It is, for example, particularly appreciated by industries which perform their assembly by bonding, in assembly lines running at high rates, for bodywork parts made of thermoplastic material for motor vehicles. Specifically, immediately on applying the adhesive to the parts to be assembled and placing them in contact, generally via automated means, the assembly is then sufficiently solidly fastened to be able to be manipulated easily and quickly on the assembly line, without any risk for its integrity.

To overcome the drawbacks of the absence of green strength of MS Polymers®, French patent application FR 2969621 describes a polyurethane bearing polyurethane-polyether and polyurethane-polyester blocks comprising at least two end blocks each consisting of a polyurethane-polyester block connected to an alkoxysilane end group. This polyurethane is obtained via a process which comprises the sequential steps:

(a) of reacting a polyether polyol with a stoichiometric excess of an aliphatic diisocyanate, to form a polyurethane-polyether block bearing at least two —NCO end groups, and then

(b) of reacting the polyurethane from step (a) with a stoichiometric excess of a polyester polyol, to form a polyurethane bearing polyurethane-polyether and polyurethane-polyester blocks comprising at least two end blocks each consisting of a polyurethane-polyester block connected to an —OH end group, and then

(c) of silylation reaction of the polyurethane bearing an —OH end group from step (b) with a stoichiometric amount of an isocyanatosilane.

The polyurethane thus obtained is advantageously homogeneous and heat-stable. It forms, after crosslinking with atmospheric moisture in the presence of a suitable catalyst, an adhesive bond which has cohesion values higher than those obtained for crosslinked MS Polymers®, and generally higher than 3 MPa.

However, this polyurethane has the drawback of using an isocyanatosilane in the silylation step (c). Specifically, on the one hand, this molecule is toxic, and said to be “CMR”, since it has Carcinogenic and Mutagenic nature and/or is toxic with respect to Reproduction. With regard to the hazards it presents to human health, its use in an industrial manufacturing process is thus subject to numerous technical constraints. On the other hand, the availability of isocyanatosilanes on the market in industrial amounts is limited, which also implies very high costs for these starting materials.

The aims of the present invention are to avoid the need to use such an isocyanatosilane, while at the same time obtaining a block polyurethane bearing alkoxysilane end groups, which gives, after crosslinking, an adhesive bond whose mechanical properties, especially the cohesion properties and the elastic properties, are further improved.

Another aim of the present invention is also to propose polymers bearing an alkoxysilane end group, which also have a “green strength” of a suitable level.

It has now been found that these aims can be achieved, totally or partly, by the poly(urea-urethane) whose production process is described below.

The invention thus relates, firstly, to a process for preparing a poly(urea-urethane) comprising blocks of polyurethane-polyether and polyurethane-polyester type, two blocks of the same type each being connected to an alkoxysilane end group via a urea function, said process comprising the sequential steps:
(i) of reacting an alcohol composition comprising a polyol A⁽ⁱ⁾ chosen from a polyether polyol A₁ or a polyester polyol A₂, with a stoichiometric excess of an aliphatic or aromatic diisocyanate B⁽ⁱ⁾, to form a polyurethane-polyether or polyurethane-polyester block bearing at least two —NCO end groups; and then
(ii) of reacting the polyurethane bearing —NCO end groups produced in step (i) with a stoichiometric excess of an alcohol composition comprising a polyol A⁽ⁱⁱ⁾ chosen from:
   A₂ if A⁽ⁱ⁾ is A₁, and
   A₁ if A⁽ⁱ⁾ is A₂;
      to form a polyurethane comprising polyurethane-polyether and polyurethane-polyester blocks comprising at least two end blocks EB⁽ⁱⁱ⁾ of the same type constituted of a block of the following type:
polyurethane-polyester if A⁽ⁱ⁾ is A₁, or
polyurethane-polyether if A⁽ⁱ⁾ is A₂;
   said two blocks EB⁽ⁱⁱ⁾ being connected directly to an —OH end group; and then
(iii) of reacting the polyurethane bearing an —OH end group produced in step (ii) with a stoichiometric excess of an aliphatic or aromatic diisocyanate B⁽ⁱⁱⁱ⁾, to form a polyurethane bearing polyurethane-polyether and polyurethane-polyester blocks comprising two —NCO end groups; and then
(iv) of reacting the polyurethane bearing an —NCO end group produced in step (iii) with a substantially stoichiometric amount of an aminosilane C derived from a primary or secondary amine.

The aminosilane used in the silylation step (iv) does not present any known risk with regard to carcinogenic or mutagenic nature and/or toxicity toward reproduction. This compound is more advantageously industrially available, and at a cost lower than that of an isocyanatosilane.

The poly(urea-urethane) obtained in the process according to the invention is homogeneous and heat-stable.

It gives, after crosslinking with atmospheric moisture and in the presence of a suitable catalyst, an adhesive bond which has cohesion values, quantified by a breaking strength measurement, which are globally of the same level as those of French patent application FR 2969621.

Furthermore, said adhesive bond offers elastic properties, quantified by an elongation at break measurement, which are very greatly increased, and generally greater than 700%. Such elastic properties make the adhesive bond particularly suitable for withstanding vibrational mechanical stresses in an assembly. These properties are thus appreciable, especially for the purpose of use in the field of transportation means (such as motor vehicles, buses, trucks, or alternatively trains or ships).

Finally, the poly(urea-urethane) thus obtained is a thermoplastic polymer (in anhydrous medium) whose melting point (measured via the differential scanning calorimetry method, also known as DSC) is between 40 and 130° C. It may thus be used as a hot-melt adhesive and applied hot to the interface of the substrates to be assembled. By solidifying at room temperature, an adhesive bond rendering the substrates integrally fastened is thus immediately created, giving the adhesive advantageous “green strength” properties.

These green strength, cohesion and elasticity properties thus allow use of said poly(urea-urethane) as a structural or semi-structural adhesive, for example as a sealing bond on the usual supports (concrete, glass, marble) in the construction field, or alternatively for bonding glazings or panels in the field of manufacturing transportation means (motor vehicles, trains, buses, boats).

Description of Steps (i) and (ii):

The alcohol composition used in step (i) (or, respectively, (ii)) comprises one or more polyols A⁽ⁱ⁾ (or, respectively, A⁽ⁱⁱ⁾); each of the polyols A⁽ⁱ⁾ and A⁽ⁱⁱ⁾ being chosen:
either from one (or more) polyether polyols A₁,
or from one (or more) polyester polyols A₂,
with the exception of a combination of A₁ and A₂.

Polyethers Polyols A₁:

The polyether polyols A₁ that may be used in step (i) or (ii) of the process according to the invention are generally chosen from aliphatic and aromatic polyether polyols. Preferably, their molecular mass is between 0.5 and 20 kDa and their hydroxyl functionality is between 2 and 4.6. The hydroxyl functionality is the mean number of hydroxyl functions per mole of polyether polyol. The molecular mass indicated is a number-average molecular mass (generally noted as Mn); this is likewise the case for all the molecular masses indicated for polymers in the present text, unless otherwise mentioned.

Examples of aliphatic polyether polyols that may be mentioned include oxyalkyl or poly(oxyalkyl) derivatives of:
diols such as ethylene glycol (or ethane-1,2-diol), propylene glycol (or propane-1,2-diol), neopentyl glycol, polytetramethylene glycol of formula:
   HO-(—(CH₂)₄O—)ₙ—OH, in which n is an integer between about 2 and 100;
triols such as glycerol, trimethylolpropane and hexane-1,2,6-triol, or
tetrols such as pentaerythritol.

These products are widely commercially available.

According to a preferred variant, the polyether polyol A₁ is a polyether diol alone or mixed with up to 30% by weight of a polyether triol.

The polyether polyol A₁ is more preferably chosen from polypropylene glycols (or PPG) with a hydroxyl functionality equal to 2 or 3, among which mention may be made of:
Voranol® EP 1900, which is a difunctional PPG with a molecular mass of about 4000 Da and a hydroxyl number I_{OH} equal to 28 mg KOH/g;
Voranol® CP 755, which is a trifunctional PPG with a molecular mass of about 700 Da and a hydroxyl number I_{OH} equal to 237 mg KOH/g;
   both available from the company Dow.

According to a particularly advantageous variant, a polypropylene glycol diol or triol whose polydispersity index ranges from 1 to 1.4 is used as polyether polyol A₁.

The polydispersity index is the ratio of the weight-average molecular mass to the number-average molecular mass. Such polypropylene glycols are commercially available under the brand name Acclaim® from the company Bayer. An example of such trifunctional PPGs that may be mentioned is Acclaim® 6300, which has a molecular mass of about 6000 Da and an I_{OH} equal to 28.3 mg KOH/g, and examples of difunctional PPGs that may be mentioned include:
Acclaim® 8200 of molecular mass 8000 Da and of I_{OH} equal to 13.5 mg KOH/g,
Acclaim® 12200 of molecular mass 12 000 Da and of I_{OH} equal to 10 mg KOH/g,
Acclaim® 18200 of molecular mass 18 000 Da and of I_{OH} equal to 6.5 mg KOH/g.

Polyester Polyol A₂:

The polyester polyols A₂ that may be used in step (i) or (ii) of the process according to the invention are generally chosen from aliphatic and aromatic polyester polyols. Preferably, their molecular mass is between 1 and 10 kDa and even more preferably between 2 and 6 kDa, and their hydroxyl functionality may range between 2 and 4. Examples that may be mentioned include:
polyester polyols of natural origin, such as castor oil;
polyester polyols resulting from the condensation of:
   one or more aliphatic polyols (linear, branched or cyclic) or aromatic, such as ethylene glycol, propylene glycol, 1,3-propanediol, glycerol, trimethylolpropane, 1,6-hexanediol, 1,2,6-hexanetriol, butenediol, sucrose, glucose, sorbitol, pentaerythritol, mannitol, triethanolamine, N-methyldiethanolamine and mixtures of these complexes, with
   one or more polycarboxylic acids or an ester or anhydride derivative thereof, such as 1,6-hexanedioic acid, dodecanedioic acid, azelaic acid, sebacic acid, adipic acid, 1,18-octadecanedioic acid, phthalic acid, succinic acid and mixtures of these acids, an unsaturated anhydride such as maleic or phthalic anhydride, or a lactone such as caprolactone.

Many of these products are commercially available.

The polyester polyol A₂ preferably chosen is a polyester polyol with a melting point of greater than or equal to 50° C., corresponding to pronounced crystallinity. Said melting point is measured via the differential scanning calorimetry method (also known as DSC). The “green strength” of the poly(urea-urethane) obtained at the end of the process according to the invention is then advantageously improved.

Among the polyester polyols A₂ that may be used, mention may thus be made of the following products with hydroxyl functionality equal to 2:
Tone® 0240 (available from Union Carbide), which is a polycaprolactone with a molecular mass of about 2000 Da, an I_{OH} equal to 56, and with a melting point of about 50° C.,
Dynacoll® 7360, which results from the condensation of adipic acid with 1,6-hexanediol, with a molecular mass of about 3500 Da, an I_{OH} equal to 30 and a melting point of about 55° C.,
Dynacoll® 7330, with a molecular mass of about 3500 Da, an I_{OH} equal to 30, and with a melting point of about 85° C.,
Dynacoll® 7363, which also results from the condensation of adipic acid with hexanediol, with a molecular mass of about 5500 Da, an I_{OH} equal to 21 and a melting point of about 57° C.,
Dynacoll® 7330, of amorphous nature, with a molecular mass of about 3000 Da, an IOH equal to 37, and with a softening point of about 76° C.,
Dynacoll® 7381, with a molecular mass of about 3500 Da, an I_{OH} equal to 30, and with a melting point of about 65° C.

The Dynacoll® products mentioned previously are sold by the company Evonik.

A polyester polyol corresponding to an advantageous embodiment of the process according to the invention is obtained by condensation of 1,6-hexanediol with adipic acid.

It is more preferred to use in step (i) or (ii) (depending on the case) of the process according to the invention one or more polyester polyols A₂ with a hydroxyl functionality ranging from 2 to 3, a functionality of 2 being more particularly preferred.

The alcohol compositions used in steps (i) and (ii) may comprise, besides the polyols A⁽ⁱ⁾ and A⁽ⁱⁱ⁾, one (or more) chain extenders, chosen from diols and polyamines with a molecular mass of between 60 and 500 Da.

As illustrations of such diols, mention may be made of ethylene glycol, propylene glycol, diethylene glycol, dipropylene glycol, 3-methyl-1,5-propanediol, 1,4-butanediol, 1,6-hexanediol, 2-ethyl-1,3-hexanediol, N,N-bis(hydroxy-2-propyl)aniline and 3-methyl-1,5-pentanediol.

As illustrations of such polyamines, mention will be made of ethylenediamine, diphenylmethanediamine, isophoronediamine, hexamethylenediamine and diethyltoluenediamine.

Description Specific to Step (i):

In accordance with step (i) of the process according to the invention, the alcohol composition comprising the polyol(s) A⁽ⁱ⁾ is reacted with one (or more) diisocyanates B⁽ⁱ⁾ of formula:

OCN—R¹—NCO (I)

in which R¹ represents an aliphatic or aromatic divalent hydrocarbon-based radical comprising from 5 to 15 carbon atoms, which may be linear, branched or cyclic.

R¹ is advantageously chosen from one of the following divalent radicals, of which the formulae below show the two free valencies:

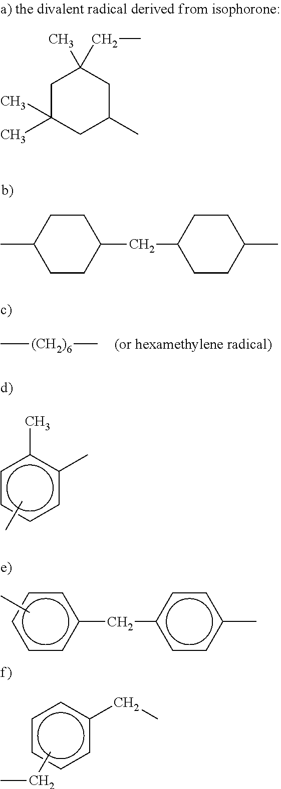

An example of a diisocyanate B⁽ⁱ⁾ that may be mentioned is the use of a composition constituted of about 95% of 2,4-toluene diisocyanate and 5% of 2,6-toluene diisocyanate, these two percentages being expressed either on a weight or molar basis as regards the two isomers. Said composition is commercially available under the name Scuranate® TX from the company Vencorex.

In step (i) of the process according to the invention, the composition comprising the polyol(s) A⁽ⁱ⁾ is reacted with an excess, in terms of the equivalent functional group, of the diisocyanate B⁽ⁱ⁾, of formula (I). This means that the amounts of the reagents used in step (i) correspond to an excess of the equivalent number of —NCO groups (present in the amount of diisocyanate) relative to the equivalent number of —OH groups (present in the amount of polyol A⁽ⁱ⁾), increased, where appropriate, by the equivalent number of —OH, —NH₂ and/or —NH— groups present in the diol and/or diamine used as chain extender.

Preferably, these amounts correspond to an —NCO/—OH equivalent ratio of between 1.3 and 5 and even more preferentially in the region of 1.9. Said ratio is defined as being equal to the equivalent number of —NCO groups divided by the equivalent number of —OH, —NH₂ and/or —NH— groups as regards the functional groups borne by the corresponding amounts of the two reagents, namely the diisocyanate(s), on the one hand, and, on the other hand, the alcohol composition comprising the polyol A⁽ⁱ⁾ and, where appropriate, a chain extender. The weight amounts of the reagents to be loaded into the reactor are determined on the basis of this equivalent ratio, and also, as regards the polyol(s) A⁽ⁱ⁾, on their hydroxyl number I_{OH}. The hydroxyl number I_{OH} is the number of hydroxyl functions per gram of polyether polyol A₁ or of polyester polyol A₂, said number being expressed, in the present text, in the form of the equivalent number of milligrams of KOH used in the assay of the hydroxyl functions.

It is preferred to perform step (i) in the presence of a catalyst chosen, for example, from organotins or bismuth/zinc carboxylates, and by introducing the appropriate amount of diisocyanate B⁽ⁱ⁾ into the appropriate amount of polyol A⁽ⁱ⁾ placed beforehand in the reactor. An example of an organotin-based reactor that may be mentioned is the catalyst based on dioctyltin dineodecanoate sold under the name Tibkat® 223 by the company TIB Chemical. An example of a bismuth/zinc carboxylate-based catalyst that may be mentioned is the catalyst sold under the name Borchi® KAT VP244 from the company Borchers GmbH. The reaction is performed at a temperature of between 60 and 120° C.

Description Specific to Step (ii):

The polyurethane-polyether or (depending on the case) the polyurethane-polyester block bearing —NCO end groups which is obtained on conclusion of step (i) is reacted in step (ii) with an alcohol composition comprising the polyol(s) A⁽ⁱⁱ⁾ chosen from:
A₂ if A⁽ⁱ⁾ is A₁, or
A₁ if A⁽ⁱ⁾ is A₂.

In other words:
if a polyurethane-polyether block bearing —NCO end groups is obtained on the conclusion of step (i), said block is reacted in the present step (ii) with an alcohol composition comprising one (or more) polyester polyols A₂;
if a polyurethane-polyester block bearing —NCO end groups is obtained on the conclusion of step (i), said block is reacted in the present step (ii) with an alcohol composition comprising one (or more) polyether polyols A₁.

The block bearing —NCO end groups which is produced in step (i) is reacted in step (ii) with a stoichiometric excess of the composition comprising the polyol A⁽ⁱⁱ⁾, in terms of equivalent functional group. The amounts of reagents used generally correspond to an —NCO/—OH equivalent ratio between 0.3 and 0.7, and preferably equal to about 0.5, the equivalent ratio being defined as previously in the description specific to step (i). The weight amounts of the reagents to be loaded into the reactor are determined on the basis of this ratio, and also, as regards the polyol A⁽ⁱⁱ⁾, on their hydroxyl number I_{OH}.

It is preferred to perform step (ii) in the presence of a catalyst chosen from those that may be used for step (i), and by introducing the appropriate amount of alcohol composition comprising the polyol A⁽ⁱⁱ⁾ into the appropriate amount of the block bearing —NCO end groups obtained in step (i) placed beforehand in the reactor. The reaction is performed at a temperature that is within a range identical to that for step (i). Advantageously, the catalyst used in this step (ii) is the one that was introduced for step (i), and that is present in the final product from step (i), used as reagent in step (ii).

A polyurethane bearing blocks of polyurethane-polyether and polyurethane-polyester type comprising at least two end blocks EB⁽ⁱⁱ⁾ of the same type, which are either a polyurethane-polyester or a polyurethane-polyether (depending on whether the polyol A⁽ⁱⁱ⁾ used in step (ii) is a polyester polyol A₂ or a polyether polyol A₁) is thus obtained on conclusion of step (ii), said two EB⁽ⁱⁱ⁾ blocks being connected directly to an —OH end group.

According to one embodiment of the process according to the invention, the alcohol composition used in step (i) is constituted of the polyol A⁽ⁱ⁾, and/or the alcohol composition used in step (ii) is constituted of the polyol A⁽ⁱⁱ⁾.

According to another embodiment of the process according to the invention, which is particularly preferred for reasons of industrial productivity, the polyol A⁽ⁱ⁾ used in step (i) is one (or more) polyether polyol A₁, and the polyol A⁽ⁱⁱ⁾ used in step (ii) is one (or more) polyester polyol A₂. Specifically, the polyurethane-polyether block bearing —NCO end groups which is then obtained on conclusion of step (i) is generally liquid at room temperature, whereas the polyurethane-polyester block bearing —NCO end groups is generally solid at room temperature.

Description of Step (iii):

The polyurethane bearing an —OH end group produced in step (ii) is reacted with a stoichiometric excess, in terms of equivalent functional group, of one (or more) aliphatic or aromatic diisocyanate(s) B⁽ⁱⁱⁱ⁾ which correspond to the same formula (I) as the diisocyanate B⁽ⁱ⁾ defined previously, which may be identical thereto or different therefrom, and is preferably identical thereto.

The amounts of the reagents used in step (iii) correspond to an excess of the equivalent number of —NCO groups (present in the amount of diisocyanate B⁽ⁱⁱⁱ⁾) relative to the equivalent number of —OH groups (present in the amount of polyurethane bearing an —OH end group produced in step (ii)).

These amounts correspond to an —NCO/—OH equivalent ratio generally between 1.7 and 4 and preferably between 2 and 3.5.

The reaction is performed under the same temperature conditions, and in the presence of the same catalyst as in the preceding steps (i) and (ii). Advantageously, the catalyst used is the one which was introduced for step (i) and is thus present in the reaction medium.

On conclusion of this step (iii), a polyurethane bearing polyurethane-polyether and polyurethane-polyester blocks comprising two —NCO end groups is obtained.

Description of Step (iv):

In accordance with step (iv) of the process according to the invention, the polyurethane bearing polyurethane-polyether and polyurethane-polyester blocks and bearing an —NCO end group, produced in step (iii), is reacted with an aminosilane C derived from a primary or secondary amine, corresponding to the formula:

R²NH—R³—Si(R⁴)ₚ(OR⁵)₃₋ₚ (II)

in which:
R² represents a hydrogen atom or a linear, branched or cyclic C₁-C₇ radical, which may be an alkyl, aliphatic or aromatic radical;
R³ represents a linear or branched divalent alkylene radical comprising from 1 to 4 carbon atoms, optionally substituted with a C₁-C₄ alkyl radical:
R⁴ and R⁵, which may be identical or different, each represent a linear or branched alkyl radical of 1 to 4 carbon atoms, with the possibility when there are several radicals R⁴ (or R⁵) that they may be identical or different; and
p is an integer equal to 0, 1 or 2.

Preferably, in formula (II):
R² represents a hydrogen atom or a C₁-C₄ alkyl radical;
R³ represents a propylene radical optionally substituted with a methyl;
p is equal to 0; and
R⁵ is a methyl.

The aminosilanes of formula (II) are widely commercially available.

An example that may be mentioned is N-ethyl-3-trimethoxysilyl-2-methylpropanamine, of formula:

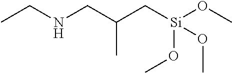

which is available under the name Silquest® A-Link 15; or alternatively 3-aminopropyltrimethoxysilane, of formula:

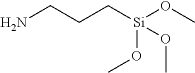

which is available under the name Silquest® A1110, both from the company Momentive.

The amounts of aminosilane C, on the one hand, and of polyurethane bearing an —NCO end group formed in step (iii), on the other hand, which are used in the present step (iv) are substantially stoichiometric. The amounts of these reagents advantageously correspond to an —NCO/—NH (or, where appropriate, —NCO/—NH₂) equivalent ratio which is between 0.90 and 1.4, and is preferably equal to about 1. Step (iv) is performed under the same temperature conditions as the preceding steps.

During this step (iv), reaction of the —NH group (or, where appropriate, the —NH₂ group) of the aminosilane of formula (II) with each of the two —NCO end groups of the polyurethane formed in step (iii), leads to the formation of a urea function.

A poly(urea-urethane) comprising blocks of polyurethane-polyether and polyurethane-polyester type, two blocks of the same type each being connected to an alkoxysilane end group via a urea function, is obtained on conclusion of step (iv).

Said final poly(urea-urethane) has a number-average molecular mass (Mn) that is within a range from 10 to 40 kDa, preferably from 15 to 30 kDa, corresponding to a polydispersity index ranging from about 2 to 5. The number-average molecular masses indicated in the present text are measured by size exclusion chromatography or GPC (gel permeation chromatography), using polystyrene as standard.

The viscosity at 100° C. (measured with a Brookfield RTV viscometer) of said final polyurethane may vary within a wide range between 15 and 150 Pa·s.

A subject of the invention is also a poly(urea-urethane) comprising blocks of polyurethane-polyether and polyurethane-polyester type, two blocks of the same type each being connected to an alkoxysilane end group via a urea function, said poly(urea-urethane) being able to be obtained via the process that is also a subject of the invention and as described previously.

The invention also relates to an adhesive composition comprising the poly(urea-urethane) according to the invention and from 0.01% to 3% by weight of a crosslinking catalyst, preferably from 0.1% to 1% by weight.

The crosslinking catalyst that may be used in the composition according to the invention may be any catalyst known to a person skilled in the art for the condensation of silanol. Examples of such acids that may be mentioned include:
organotitanium derivatives, such as titanium acetylacetonate (commercially available under the name Tyzor® AA-75 from the company Dupont),
organoaluminum derivatives such as aluminum chelate (commercially available under the name K-KAT® 5218 from the company King Industries),
organotin derivatives such as dibutyltin dilaurate (or DBTL) or dioctyltin dineodecanoate, which is sold under the name Tibkat® 223 as mentioned previously,
amines such as 1,8-diazobicyclo(5.4.0)undecene-7 or DBU.

UV stabilizers such as amines, antioxidants or up to 50% by weight and preferably up to 30% by weight of compatible tackifying resins may also be included in the composition according to the invention.

The antioxidants may include primary antioxidants, which trap free radicals and which are generally substituted phenols, such as Irganox® 1010 or Irganox® 245 from Ciba. The primary antioxidants may be used alone or in combination with other antioxidants, such as phosphites, for instance Irgafos® 168 also from Ciba.

As regards the tackifying resin(s) that may be included in the composition according to the invention, the term “compatible tackifying resin” denotes a tackifying resin which, when mixed in 50%/50% proportions with the polymer according to the invention, gives a substantially homogeneous mixture.

These tackifying resins are advantageously chosen from:
(i) resins obtained by polymerization of terpenic hydrocarbons and of phenols, in the presence of Friedel-Crafts catalysts;
(ii) resins obtained via a process comprising the polymerization of α-methylstyrene, said process also possibly comprising a reaction with phenols,
(iii) rosins of natural origin or modified rosins, for instance the rosin extracted from pine gum, wood rosin extracted from tree roots and derivatives thereof which are hydrogenated, dimerized, polymerized or esterified with monoalcohols or polyols, such as glycerol or pentaerythritol;
(iv) resins obtained by hydrogenation, polymerization or copolymerization (with an aromatic hydrocarbon) of mixtures of unsaturated aliphatic hydrocarbons containing approximately 5, 9 or 10 carbon atoms derived from petroleum fractions;
(v) terpenic resins generally resulting from the polymerization of terpenic hydrocarbons, for instance monoterpene (or pinene), in the presence of Friedel-Crafts catalysts;
(vi) copolymers based on natural terpenes, for example styrene/terpene, α-methylstyrene/terpene and vinyltoluene/terpene; or alternatively
(vii) acrylic resins having a viscosity at 100° C. of less than 100 Pa·s.

The resins (ii) are particularly preferred on account of their advantageous compatibility with the poly(urea-urethane) according to the invention. Such a resin is sold, for example, under the name Sylvares® 525 by the company Arizona Chemicals.

The composition according to the invention may also comprise other (co)polymers chosen, for example, from:
ethylene/vinyl acetate (EVA) copolymers,
acrylic polymers,
amorphous poly-alpha-olefins (commonly referred to by the abbreviation APAO) and preferentially reactive amorphous poly-alpha-olefins (known as RAPAO) grafted with alkoxysilyl groups,
styrene block copolymers such as styrene-isoprene-styrene (SIS),
polyethylene, polypropylene, polyamides or polyesters.

The composition according to the invention is, prior to its final use, preferably packaged in airtight packaging to protect it from ambient moisture. Such packaging may advantageously consist of aluminum, high-density polyethylene or polyethylene coated with aluminum foil. A cylindrical cartridge is one embodiment of such packaging.

Finally, the invention relates to a process for assembling two substrates, comprising:
the melting of the adhesive composition as defined previously, by heating to a temperature of between 40 and 130° C., and then
coating it, in the form of a layer with a thickness between 0.3 and 5 mm, preferably between 1 and 3 mm, onto at least one of the two substrates to be assembled, and then
without exceeding a time period corresponding to the maximum open time of the adhesive composition, placing the two substrates in effective contact.

The maximum open time is the time interval after which an adhesive layer applied to a substrate loses its ability to fix said substrate to another substrate by bonding. The maximum open time of the adhesive composition according to the invention is generally between 1 and 4 minutes.

The appropriate substrates are, for example, inorganic substrates, such as glass, ceramics, concrete, metals or alloys (such as aluminum, steel, non-ferrous metals and galvanized metals); or else organic substrates such as wood, plastics, such as PVC, polycarbonate, PMMA, polyethylene, polypropylene, polyesters or epoxy resins; substrates made of metal and composites coated with paint (as in the motor vehicle field).

The following examples are given purely by way of illustration of the invention and should not be interpreted as limiting the scope thereof.

### EXAMPLE 1

A) Preparation of a Poly(Urea-Urethane) Bearing an Alkoxysilane End Group According to the Invention:

Step (i): Synthesis of a Polyurethane-Polyether Block with Two —NCO End Groups:

The following are placed in a closed 250 ml reactor equipped with a stirrer, heating means and a thermometer, and connected to a vacuum pump:
34.0 g of polypropylene glycol Voranol® EP 1900 having a hydroxyl number of 28.0 mg KOH/g (corresponding to an equivalent number of —OH functions equal to 0.499 mmol/g); and
0.5 g of antioxidant Irganox® 245.

The assembly is heated to 80° C. and maintained at a reduced pressure of 20 mbar for 1 hour to dehydrate the polypropylene glycol.

The following are then introduced at 80° C., under a stream of nitrogen:
2.8 g of toluene diisocyanate Scuranate® TX (with a 48.2% weight/weight titer of —NCO groups, i.e. an equivalent number of —NCO functions equal to 11.481 mmol/g); and then
30 mg of a bismuth/zinc carboxylate catalyst (Borchi® Kat VP244 from the company Borchers GmbH);
   the amounts introduced thus corresponding to an —NCO/—OH equivalent ratio equal to 1.9.

The polyaddition reaction is continued for 1 hour 30 minutes until 37.33 g of a polyurethane-polyether block with a 1.7% weight/weight titer of —NCO groups (i.e. 0.406 mmol/g) are obtained in the form of a viscous liquid. The polyurethane-polyether block thus obtained has a Brookfield viscosity of 10 Pa·s at 23° C.

Step (ii): Synthesis of a polyurethane bearing polyurethane-polyether and polyurethane-polyester blocks comprising two polyurethane-polyester end blocks connected to an —OH function:

54.7 g of a crystalline polyester diol Dynacoll® 7360 with a number-average molecular mass of 3500 Da and a hydroxyl number I_{OH} of 30.0 mg KOH per gram (corresponding to an equivalent number of —OH functions equal to 0.535 mmol/g) are placed in a closed 250 ml reactor equipped with a stirrer, heating means and a thermometer, and connected to a vacuum pump. The assembly is heated to 90° C. and maintained at a reduced pressure of 20 mbar for 1 hour to dehydrate the polyester diol.

The reactor is then brought again to atmospheric pressure and maintained under an inert atmosphere to introduce 37.33 g of the polyurethane-polyether block with a titer obtained in step (i) with a titer of 0.406 mmol/g of —NCO groups.

The amounts of the polyester diol and of the polyurethane-polyether block obtained in step (i) correspond to an —NCO/—OH equivalent ratio equal to 0.5.

The reactor is then flushed again and the polyaddition reaction is continued for 1 hour 30 minutes at 90° C. until the —NCO functions of the polyurethane-polyether block from step (i) have been totally consumed (detected by disappearance of the —NCO band at 2300 cm⁻¹ by infrared spectroscopy).

92.03 g of a polyurethane bearing polyurethane-polyether and polyurethane-polyester blocks comprising two polyurethane-polyester end blocks each connected to an —OH function are obtained, the —OH function content of which is 0.153 mmol/g.

Step (iii): Synthesis of a Polyurethane Bearing Polyurethane-Polyether and Polyurethane-Polyester Blocks Comprising Two Polyurethane-Polyester End Blocks Bearing —NCO End Groups:

3.9 g of toluene diisocyanate Scuranate® TX (with a 48.2% weight/weight titer of —NCO groups, i.e. an equivalent number of —NCO functions equal to 11.481 mmol/g) are then introduced at 90° C., under a stream of nitrogen, into the reactor from step (ii).

The polyaddition reaction is continued for 1 hour at 90° C. until 95.93 g of a polyurethane bearing polyurethane-polyether and polyurethane-polyester blocks comprising two polyurethane-polyester end blocks bearing —NCO end groups, with a titer of 1.3% weight/weight of —NCO groups, i.e. 0.310 mmol/g, are obtained.

The amounts of polyurethane obtained in step (ii) and of diisocyanate used correspond to an —NCO/—OH equivalent ratio equal to 3.2.

Step (iv): Synthesis of a Poly(Urea-Urethane) Bearing Polyurethane-Polyether and Polyurethane-Polyester Blocks Comprising Two Polyurethane-Polyester End Blocks Each Connected to an Alkoxysilyl End Group:

4.07 g of gamma-aminopropyltrimethoxysilane Silquest® A 1110 (with a titer of 5.577 mmol/g of —NH₂ groups), corresponding to an —NCO/—NH₂ equivalent ratio equal to 1.31 are then introduced at 90° C. into the reactor from step (iii), under a stream of nitrogen.

The reactor is then maintained under an inert atmosphere at 90° C. for 30 minutes until the reaction is complete (detected by disappearance of the —NCO band at 2300 cm⁻¹ on infrared spectroscopy).

100.0 g of a poly(urea-urethane) bearing polyurethane-polyether and polyurethane-polyester blocks comprising two polyurethane-polyester end blocks each connected to an alkoxysilyl end group are obtained.

Its Brookfield RTV viscosity measured at 100° C. is 44.4 Pa·s.

Its number-average molecular mass is 18 kDa.

Its melting point, measured by DSC, is 45° C.

B) Corresponding Composition:

0.05% by weight of a crosslinking catalyst constituted of dibutyltin dineodecanoate (available, for example, from the company TIB Chemicals) is introduced into the poly(urea-urethane) obtained in the reactor from step iv).

The composition obtained is stirred under reduced pressure of 20 mbar for 15 minutes and then packaged in an aluminum cartridge to avoid the presence of moisture.

The composition is then subjected to the following tests.

Measurement of the Breaking Strength and the Elongation at Break by Tensile Testing:

The principle of the measurement consists in stretching, in a tensile testing machine whose mobile jaw moves at a constant speed equal to 100 mm/minute, a standard test specimen constituted of the crosslinked adhesive composition and in recording, at the time when the test specimen breaks, the applied tensile stress (in MPa) and the elongation of the test specimen (in %).

The standard test specimen is dumbbell-shaped, as illustrated in international standard ISO 37. The narrow part of the dumbbell used has a length of 20 mm, a width of 4 mm and a thickness of 500 μm.

To prepare the dumbbell, the composition packaged as described previously is heated to 100° C., followed by extrusion on an A4 sheet of silicone paper of the amount required to form thereon a film 500 μm thick, which is left for 2 weeks at 23° C. and 55% relative humidity for crosslinking. The dumbbell is then obtained by simply cutting it out from the crosslinked film.

The results of the measurements obtained are given in the table 2.

Test for Measuring the Solidification Time of the Adhesive Composition:

This test is used to quantify the green strength of the adhesive composition prepared previously.

Two identical rectangular blocks of wood (10 cm long, 2 cm wide and 1 cm thick) are assembled by arranging them perpendicularly along a square contact zone with a side length of 2 cm located at their end. This is done in the following manner.

The composition packaged as described previously is heated to 100° C., so as to extrude a bead of adhesive 2 mm in diameter and 2 cm long, which is deposited parallel to the width of one of the two blocks substantially in the middle of the square zone with a side length of 2 cm that is intended to be placed in contact with the other block.

After depositing said bead, the two blocks are placed in contact and pressed manually so as to form on their contact zone (defined as previously) a layer of adhesive composition between 200 and 250 μm thick.

Once the assembly has thus been made, the operator holds in each hand the remaining free end of the two blocks, and applies on the assembly a small-amplitude swivel tending to open and close by a few degrees the right angle formed by the two blocks.

The solidification time is defined as being the time, counting from the production of the assembly, after which the cohesion achieved by the adhesive bond connecting the two blocks no longer allows the abovementioned swivelling.

The result is given in table 2.

### EXAMPLES 2-4

A poly(urea-urethane) according to the invention is prepared by repeating example 1 A), with the exception of introduction of the following:
in step (ii), the polyester polyol(s) A₂ indicated in table 1 in a weight amount corresponding to the —NCO/—OH equivalent ratio indicated in table 1;
in step (iii), Scuranate® TX in a weight amount corresponding to the —NCO/—OH equivalent ratio indicated in table 1;
in step (iv), the aminosilane C indicated in table 1, in a weight amount corresponding to the —NCO/—NH₂ equivalent ratio indicated in table 1.

The weight amounts of the reagents introduced during the synthesis are indicated in table 1, expressed on the basis of 100 g of the final poly(urea-urethane) obtained.

The results of the Brookfield RTV viscosity measurement measured at 100° C. are indicated in table 2.

For each of these poly(urea-urethanes), a composition is prepared by repeating Example 1B).

The results of the breaking strength and elongation at break measurements by tensile testing, and also of the solidification time, are also indicated in table 2.

### EXAMPLE 5

A poly(urea-urethane) according to the invention is prepared by repeating example 1 A), with the exception of introduction of the following:
in step (i) Acclaim® 8200 and Scuranate® TX in a weight amount corresponding to an —NCO/—OH equivalent ratio of 2.6;
in step (iii), Scuranate® TX in a weight amount corresponding to an —NCO/—OH equivalent ratio of 2.79;
in step (iv), Silquest® A 1110 in a weight amount corresponding to an —NCO/—NH₂ equivalent ratio of 1.11.

A composition constituted of 80% by weight of the poly(urea-urethane) thus obtained and 20% by weight of the tackifying resin Sylvares® 525 is then prepared.

The weight contents:
of the reagents introduced during the synthesis of said poly(urea-urethane), and
of the tackifying resin Sylvares® 525
   are expressed on the basis of 100 g of said composition and indicated in table 1.

The result of the Brookfield RTV viscosity measurement measured at 100° C. is indicated in table 2.

0.05% by weight of the crosslinking catalyst constituted of dibutyltin dineodecanoate is then added to said composition.

The resulting composition obtained is stirred under reduced pressure of 20 mbar for 15 minutes and then packaged in an aluminum cartridge to avoid the presence of moisture.

It is then subjected to the breaking strength and elongation at break measurements by tensile testing, and also the solidification time measurement, as described in example 1 B).

### EXAMPLE A (COMPARATIVE)

Example 1A) is repeated, except that, after step (ii), the polyurethane bearing polyurethane-polyether and polyurethane-polyester blocks bearing —OH end groups is reacted with gamma-isocyanato-n-propyltrimethoxysilane (commercial product: Geniosil® GF 40) in an amount corresponding to an —NCO/—OH equivalent ratio equal to 1.14.

A polyurethane bearing polyurethane-polyether and polyurethane-polyester blocks in accordance with the teaching of patent FR 2969621 is thus obtained.

The results of the Brookfield RTV viscosity measurement measured at 100° C. and the number-average molecular mass are indicated in table 2.

For the polyurethane thus obtained, a composition is then prepared by repeating Example 1B).

The results of the breaking strength and elongation at break measurements by tensile testing, and also of the solidification time, are also indicated in table 2.

TABLE 1

| | | | Example | | | | |
|---|---|---|---|---|---|---|---|
| | | | 1 | 2 | 3 | 4 | 5 |
| step (i) | Polyether | Voranol ® EP 1900 | 34.00 | 34.37 | 35.15 | 35.02 | — |
| | polyol A₁ | Acclaim ® 8200 | — | — | — | — | 28.12 |
| | Diisocyanate B⁽ⁱ⁾ | Scuranate ® TX | 2.80 | 2.83 | 2.95 | 2.91 | 1.60 |
| | Antioxidant | Irganox ® 245 | 0.50 | 0.50 | 0.50 | 0.50 | 0.40 |
| | Catalyst | Borchi ® KAT VP244 | 0.03 | 0.03 | 0.03 | 0.03 | 0.02 |
| | −NCO/−OH equivalent ratio | | 1.9 | 1.9 | 1.9 | 1.9 | 2.6 |
| step (ii) | Polyester | Dynacoll ® 7360 | 54.70 | — | 48.36 | 53.81 | 43.52 |
| | polyol A₂ | Dynacoll ® 7330 | — | 55.29 | — | — | — |
| | | Dynacoll ® 7130 | — | — | 5.38 | — | — |
| | −NCO/−OH equivalent ratio | | 0.50 | 0.5 | 0.56 | 0.55 | 0.49 |
| step (iii) | Diisocyanate B⁽ⁱⁱⁱ⁾ | Scuranate ® TX | 3.90 | 3.03 | 3.86 | 3.01 | 2.90 |
| | −NCO/−OH equivalent ratio | | 3.2 | 2.5 | 2.67 | 2.68 | 2.79 |
| step (iv) | Aminosilane C | Silquest ® A1110 | 4.07 | 3.95 | 3.77 | — | 3.44 |
| | | Silquest ® A-link15 | — | — | — | 4.72 | — |

| | | | | | |
|---|---|---|---|---|---|
| −NCO/−NH₂ equivalent ratio | 1.31 | 0.93 | 0.98 | 1.01 | 1.11 |

| | | | | | | |
|---|---|---|---|---|---|---|
| Tackifying resin (in | Sylvares ® 525 | — | — | — | — | 20 |
| weight %) | | | | | | |

TABLE 2

| | Example | | | | | |
|---|---|---|---|---|---|---|
| | | | | | | A |
| | | | | | | (compar- |
| | 1 | 2 | 3 | 4 | 5 | ative) |
| Brookfield RTV | 44.4 | 21.7 | 45.7 | 31.7 | 284 | 19.5 |
| viscosity at 100° C. | | | | | | |
| (in Pa · s) | | | | | | |
| Breaking strength | 11.2 | 10.8 | 6.8 | 7.5 | 8.9 | 5.2 |
| (in MPa) | | | | | | |
| Elongation at break | 917 | 730 | 944 | 1170 | 1100 | 580 |
| (in %) | | | | | | |
| Solidification time | 20 | 10 | 160 | 50 | 55 | 70 |
| (in s) | | | | | | |

1. A process for preparing a poly(urea-urethane) comprising blocks of polyurethane-polyether and polyurethane-polyester type, two blocks of the same type each being connected to an alkoxysilane end group via a urea function, said process comprising the sequential steps:
(i) of reacting an alcohol composition comprising a polyol A⁽ⁱ⁾ chosen from a polyether polyol A₁ or a polyester polyol A₂, with a stoichiometric excess of an aliphatic or aromatic diisocyanate B⁽ⁱ⁾, to form a polyurethane-polyether or polyurethane-polyester block bearing at least two —NCO end groups; and then
(ii) of reacting the polyurethane bearing —NCO end groups produced in step (i) with a stoichiometric excess of an alcohol composition comprising a polyol A⁽ⁱⁱ⁾ chosen from:
A₂ if A⁽ⁱ⁾ is A₁, and
A₁ if A⁽ⁱ⁾ is A₂;
to form a polyurethane comprising polyurethane-polyether and polyurethane-polyester blocks comprising at least two end blocks EB⁽ⁱⁱ⁾ of the same type constituted of a block of the following type:
polyurethane-polyester if A⁽ⁱ⁾ is A₁, or
polyurethane-polyether if A⁽ⁱ⁾ is A₂;
said two blocks EB⁽ⁱⁱ⁾ being connected directly to an —OH end group; and then
(iii) reacting the polyurethane bearing an —OH end group produced in step (ii) with a stoichiometric excess of an aliphatic or aromatic diisocyanate B⁽ⁱⁱⁱ⁾ to form a polyurethane bearing polyurethane-polyether and polyurethane-polyester blocks comprising two —NCO end groups; and then
(iv) reacting the polyurethane bearing an —NCO end group produced in step (iii) with a substantially stoichiometric amount of an aminosilane C derived from a primary or secondary amine.

2. The preparation process as claimed in claim 1, characterized in that the polyether polyol A₁ is a polypropylene glycol with a hydroxyl functionality equal to 2 or 3.

3. The preparation process as claimed in claim 1, characterized in that the polyester polyol A₂ has a melting point of greater than or equal to 50° C.

4. The preparation process as claimed in claim 1, characterized in that the polyester polyol A₂ has a hydroxyl functionality ranging from 2 to 3 and preferably equal to 2.

5. The preparation process as claimed in claim 1, characterized in that the diisocyanate B⁽ⁱ⁾ has the formula:
OCN—R¹—NCO (I)
in which R¹ represents an aliphatic or aromatic divalent hydrocarbon-based radical comprising from 5 to 15 carbon atoms, which may be linear, branched or cyclic.

6. The preparation process as claimed in claim 5, characterized in that R¹ is chosen from one of the following divalent radicals: 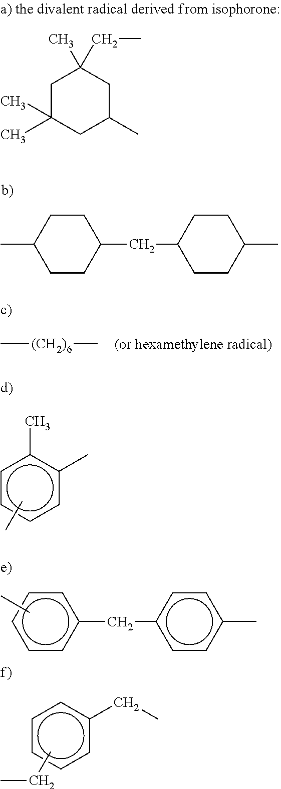
d)

7. The preparation process as claimed in claim 1, characterized in that the amounts of the reagents used in step (i) correspond to an —NCO/—OH equivalent ratio of between 1.3 and 5, preferably in the region of 1.9.

8. The preparation process as claimed in claim 1, characterized in that the amounts of the reagents used in step (ii) correspond to an —NCO/—OH equivalent ratio of between 0.3 and 0.7, preferably equal to about 0.5.

9. The preparation process as claimed in claim 1, characterized in that the polyol A⁽ⁱ⁾ is a polyether polyol A₁, and the polyol A⁽ⁱⁱ⁾ is a polyester polyol A₂.

10. The preparation process as claimed in claim 1, characterized in that the diisocyanate B⁽ⁱⁱⁱ⁾ is identical to the diisocyanate B⁽ⁱ⁾.

11. The preparation process as claimed in claim 1, characterized in that the amounts of the reagents used in step (iii) correspond to an —NCO/—OH equivalent ratio of between 1.7 and 4, preferably between 2 and 3.5.

12. The preparation process as claimed in claim 1, characterized in that the aminosilane C corresponds to the formula:
R²NH—R³—Si(R⁴)ₚ(OR⁵)₃₋ₚ (II)
in which:
R² represents a hydrogen atom or a linear, branched or cyclic C₁-C₇ radical, which may be an alkyl, aliphatic or aromatic radical;
R³ represents a linear or branched divalent alkylene radical comprising from 1 to 4 carbon atoms, optionally substituted with a C₁-C₄ alkyl radical:
R⁴ and R⁵, which may be identical or different, each represent a linear or branched alkyl radical of 1 to 4 carbon atoms, with the possibility when there are several radicals R⁴ (or R⁵) that they may be identical or different; and
p is an integer equal to 0, 1 or 2.

13. The preparation process as claimed in claim 1, characterized in that the amounts of the reagents used in step (iv) correspond to an —NCO/—NH (or, where appropriate, —NCO/—NH₂) equivalent ratio of between 0.90 and 1.4, preferably equal to about 1.

14. A poly(urea-urethane) comprising blocks of polyurethane-polyether and polyurethane-polyester type, two blocks of the same type each being connected to an alkoxysilane end group via a urea function, said poly(urea-urethane) being able to be obtained via the process as defined in claim 1.

15. An adhesive composition comprising the poly(urea-urethane) as defined in claim 14 and from 0.01% to 3% by weight of a crosslinking catalyst.

16. The adhesive composition as claimed in claim 15, characterized in that it comprises up to 50% by weight of compatible tackifying resins.

17. A process for assembling two substrates, comprising:
the melting of the adhesive composition as defined in claim 16, by heating to a temperature of between 40 and 130° C., and then
coating it, in the form of a layer with a thickness between 0.3 and 5 mm, preferably between 1 and 3 mm, onto at least one of the two substrates to be assembled, and then
without exceeding a time period corresponding to the maximum open time of the adhesive composition, placing the two substrates in effective contact.
